(19) United States
(12) Patent Application Publication
(10) Pub. No.: US 2017/0072889 A1
(43) Pub. Date: Mar. 16, 2017

(54) VEHICLE ROOF IMPACT ABSORBING APPARATUS INCLUDING A DEPLOYABLE DEVICE

(71) Applicant: Ford Global Technologies, LLC, Dearborn, MI (US)

(72) Inventors: Michael James Whitens, Milford, MI (US); Dean M. Jaradi, Macomb, MI (US); Mohammed Omar Faruque, Ann Arbor, MI (US); Iskander Farooq, Novi, MI (US)

(73) Assignee: FORD GLOBAL TECHNOLOGIES, LLC, Dearborn, MI (US)

(21) Appl. No.: 14/855,823

(22) Filed: Sep. 16, 2015

(51) Int. Cl. B60R 21/13; B60R 21/214

(52) U.S. Cl. CPC B60R 21/13; B60R 21/214; B60R 21/013

(57) ABSTRACT

A deployable device of a roof impact absorbing apparatus for a vehicle includes a bottom panel, a top panel opposite the bottom panel, and a cavity between the top panel and the bottom panel. The roof impact absorbing apparatus includes a headliner adjacent to the bottom panel, and an inflator in communication with the cavity. The deployable device is formed of a thermoplastic elastomer and is flexible relative to the headliner. During a rollover of the vehicle, the deployable device in the deployed position may reduce the amount of impact energy transferred to the occupant.

### BACKGROUND

A vehicle rollover occurs when momentum of the vehicle urges the vehicle to roll over onto its roof, e.g., rolling about a longitudinal axis of the vehicle. Vehicle rollovers may be single-vehicle events, for example, those that result when the vehicle drives off a road and contacts a ditch, curb, soft soil, etc., which may create forces on the vehicle that urge the vehicle to roll over. Vehicle rollovers may also occur during a vehicle-to-vehicle impact. The National Highway Traffic Safety Administration (NHTSA) with its New Car Assessment Program (NCAP), for example, rates vehicles for their resistance to rollovers in the event of a single vehicle event

During a rollover, the head of the occupant may contact the headliner of the interior of the vehicle. There remains an opportunity to design a device to reduce the amount of impact energy transferred from the headliner to the occupant during a rollover.

### BRIEF DESCRIPTION OF THE DRAWINGS

FIG. 1 is a perspective view of a portion of a vehicle including a roof panel and a roof impact absorbing apparatus disposed beneath the roof panel.

FIG. 2A is a perspective view of a portion of the vehicle including the roof impact absorbing apparatus having a headliner and a first embodiment of a deployable device in an undeployed position disposed between the headliner and the roof panel.

FIG. 2B is a perspective view of FIG. 2A with the deployable device in a deployed position.

FIG. 3A is a cross-sectional view taken along line 3 of FIG. 2A.

FIG. 3B is a cross-sectional view taken along line 3 of FIG. 2B.

FIG. 4 is a perspective view of a second embodiment of the deployable device in the undeployed position.

FIG. 5A is a cross-sectional view of the second embodiment of the deployable device taken along line 5 of FIG. 4.

FIG. 5B is the cross-sectional view of FIG. 5A with the deployable device in the deployed position.

FIG. 6 is a schematic of a rollover impact absorbing system.

### DETAILED DESCRIPTION

With reference to the Figures, wherein like numerals indicate like parts throughout the several views, a roof impact absorbing apparatus 12 for a vehicle 14 includes a headliner 22 and an deployable device 10, 100. The deployable device 10, 100 includes a bottom panel 16, 116 adjacent the headliner 22, a top panel 18, 118 opposite the bottom panel 16, 116, and a cavity 20 between the top panel 18, 118 and the bottom panel 16, 116. An inflator 24 is in communication with the cavity 20. The deployable device 10, 100 is formed of a thermoplastic elastomer and is flexible relative to the headliner 22.

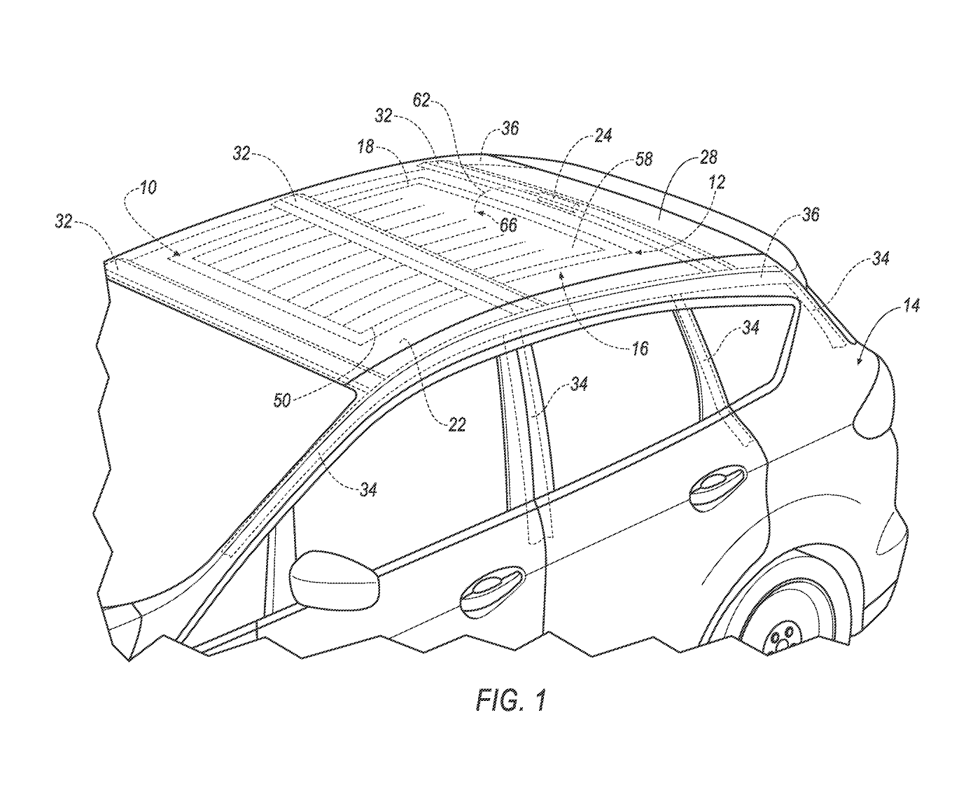

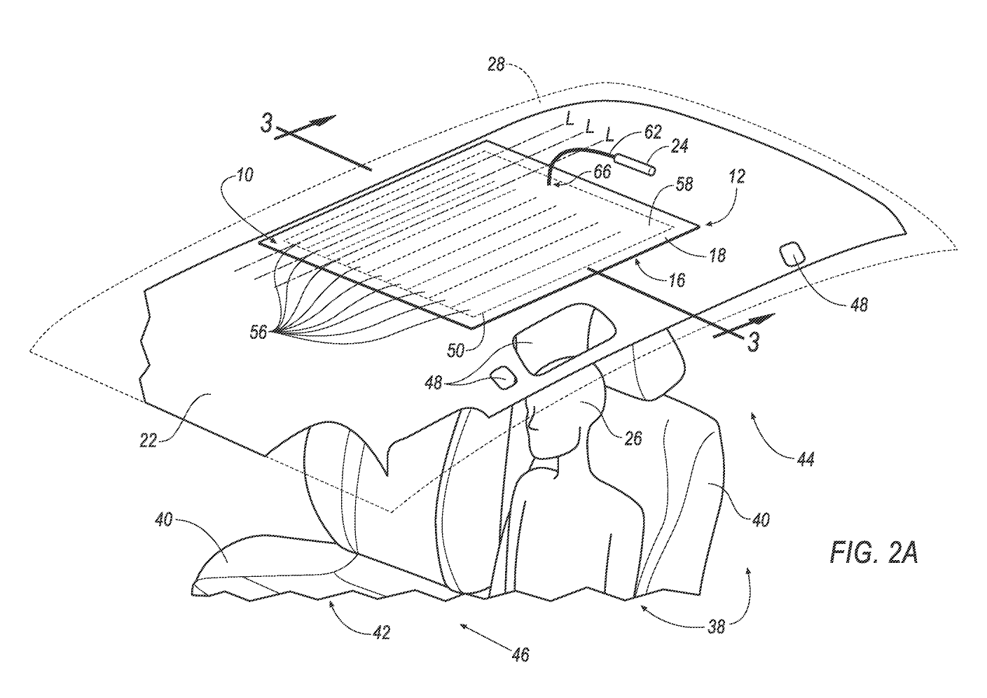

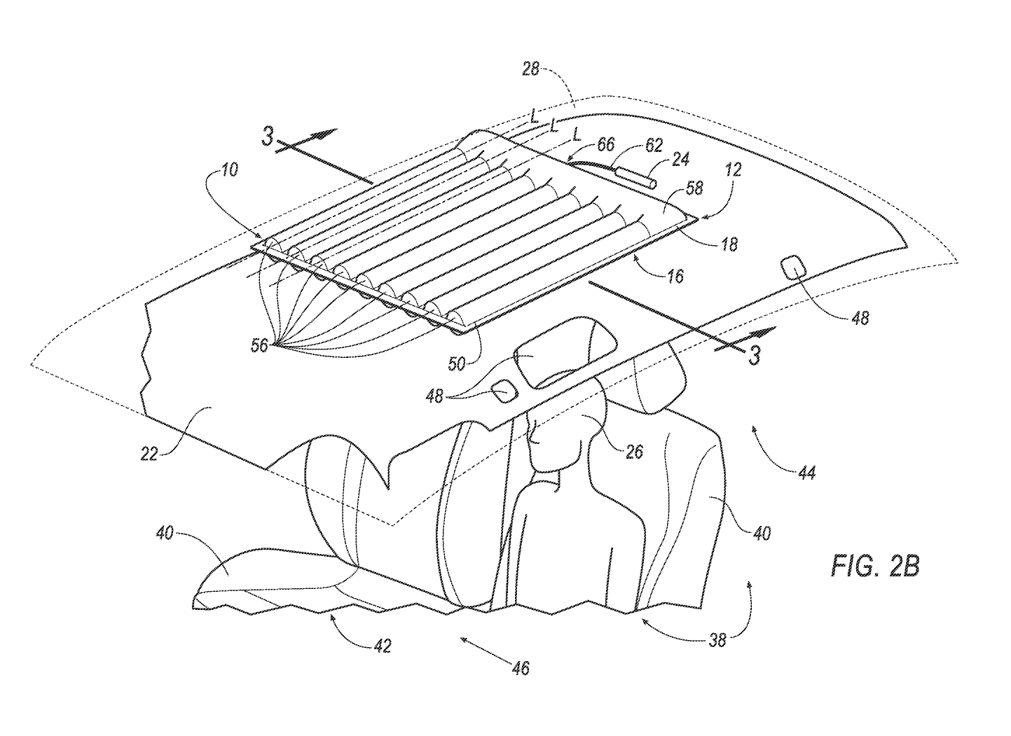

As set forth further below, absent a vehicle rollover condition, the deployable device 10, 100 is in an undeployed position, as shown in FIGS. 1, 2A, 3A, 4 and 5A. During a rollover of the vehicle 14, the deployable device 10, 100 may be inflated to an deployed position, as shown in FIGS. 2B, 3B and 5B, to assist in cushioning the impact between the headliner 22 and an occupant 26, e.g., a head of the occupant 26. In particular, for example, the deployable device 10, 100 in the undeployed position may be positioned, i.e., sandwiched, between the headliner 22 and a roof panel 28 of the vehicle 14, and may extend directly over one or more occupants 26 of the vehicle 14. When a rollover is sensed, as set for the further below, the deployable device 10, 100 may deploy causing the deployable device 10, 100 to press against the roof panel 28 and push the headliner 22 toward the occupant 26, thus increasing the space between the headliner 22 and the roof panel 28. In this rollover situation, as the occupant 26 moves toward the headliner 22, the deployable device 10, 100 in the deployed position may absorb energy from the occupant 26. In addition, the roof impact absorbing apparatus 12 may be integrated into existing vehicles without the need for major structural alterations, which may reduce development time and cost.

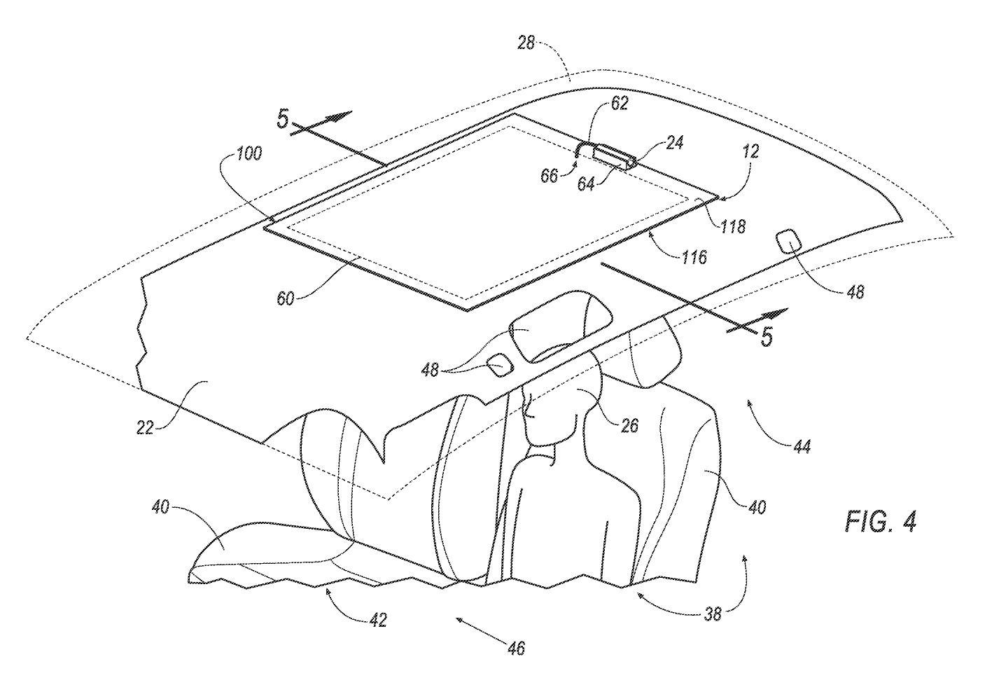

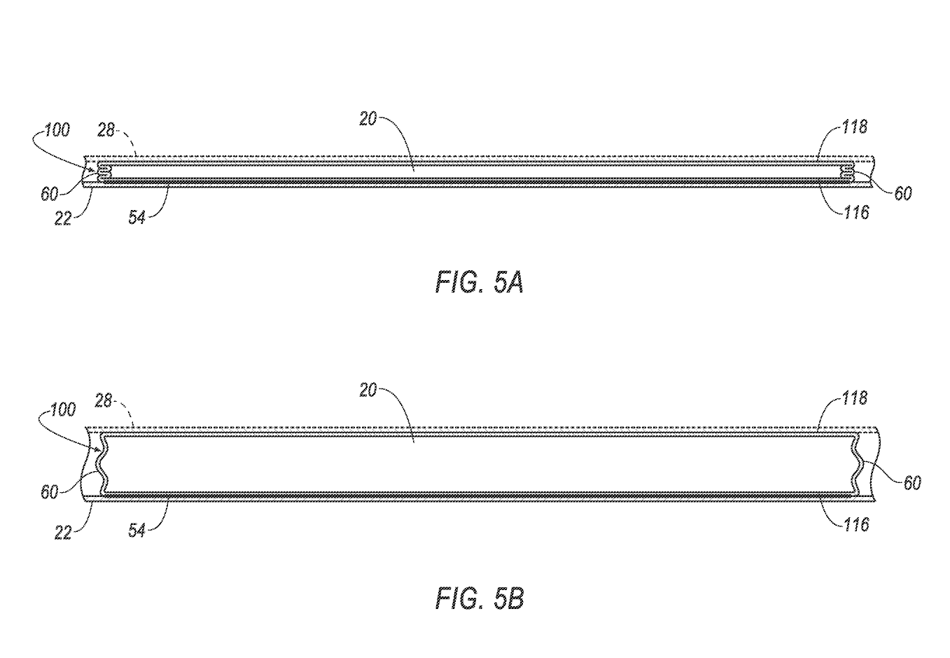

As set forth further below, a first embodiment of the deployable device 10 is shown in FIGS. 1-3B, and a second embodiment of the deployable device 100 is shown in FIGS. 4-5B. As further set forth below, the cavity 20 of the first embodiment of the deployable device 10 may be divided into channels 56. The cavity 20 of the second embodiment of the deployable device 100 may be undivided.

With reference to FIG. 1, the vehicle 14 includes the roof panel 28, and structural components, e.g., crossmembers 32, pillars 34, and side rails 36 that generally define a passenger compartment 38 of the vehicle 14. The vehicle 14 may be any passenger or commercial vehicle including car, truck, sport utility vehicle, crossover vehicle, or the like.

The crossmembers 32 may be spaced along the roof panel 28 and fixed to the side rails 36 and the roof panel 28. Three crossmembers 32, for example, are shown in FIG. 1. The pillars 34 and side rails 36 may be formed from any suitable process, and fixed together in any suitable manner. The crossmembers 32, pillars 34 and side rails 36 may be formed of any suitable material, e.g., sheet metal such as steel, aluminum, etc.

The roof panel 28 of the vehicle 14 spans the crossmembers 32, pillars 34, and side rails 36. The roof panel 28 may be fixed to the crossmembers 32, pillars 34, and/or side rails 36. The roof panel 28 may be formed of any suitable material, e.g., sheet metal such as steel, aluminum, etc.

With reference to FIGS. 2A, 2B, and 4, the vehicle 14 may include a front seat 40 located in the passenger compartment 38. The front seat 40 generally defines a front passenger area 42 and a rear passenger area 44. A rear seat (not shown) may be located in the rear passenger area 44 of the passenger compartment 38. As shown in FIGS. 2A, 2B, and 4, for example, the vehicle 14 includes two adjacent front seats 40 arranged in a front row 46. The vehicle 14 may include any suitable number of front seats 40 and rear seats arranged in any suitable number of rows.

With reference to FIGS. 1-5B, the headliner 22 may extend across the passenger compartment 38, e.g., the front passenger area 42, and the rear passenger area 44. The headliner 22 may define openings 48 through the headliner 22 for the attachment of accessories, such as infotainment devices, air ducts, sun visors, grab handles, coat hooks, etc. For example, three such openings 48 are shown in FIGS. 2A, 2B and 4.

The headliner 22 may be fixed to the roof panel 28 and/or the crossmembers 32 in any suitable fashion, e.g., by fasteners (not shown), magnets (not shown), etc. As set forth above and further described below, the deployable device 10, 100 may be fixed to the headliner 22. As the deployable device 10, 100 deploys from the undeployed position to the deployed position, the deployable device 10, 100 may force the headliner 22 to bulge, and the headliner 22 may remain fixed to the roof panel 28 and/or the crossmembers 32. Alternatively, the deployable device 10, 100 may disconnect the headliner 22 from the roof panel 28 and/or crossmembers 32 and move the headliner 22 away from the roof panel 28 and/or crossmembers 32. The fasteners, magnets, etc., that connect the headliner 22 to the roof panel 28 and/or crossmembers 32 may be designed to disconnect from the roof panel 28 and/or crossmembers 32 as the deployable device 10, 100 is inflated to the deployed position.

The headliner 22 may be formed of various layers of suitable material. A layer closest to the passenger compartment 38 may be formed of fabric or fabric-like material, e.g., knitted fabric, which may be selected for durability and also appearance, since this layer is visible within the passenger compartment 38 of the vehicle 14. In other words, this layer closest to the passenger compartment 38 may have a class-A surface. A layer of the headliner 22 for reinforcement may be formed of any suitable thermoplastic, e.g., polyethylene terephthalate (PET), etc. A layer of the headliner 22 closest to the roof panel 28 may be formed of a demoulding film coupled to a scrim. The demoulding film may be formed of any suitable material, e.g., polyethylene, etc. The scrim may be formed of any suitable material, e.g., polyethersulfone (PES), etc. The headliner 22 may include additional layers of foam, e.g., polyurethane foam, and glass fiber mat, e.g., fiberglass. All layers may be attached to each other with adhesive.

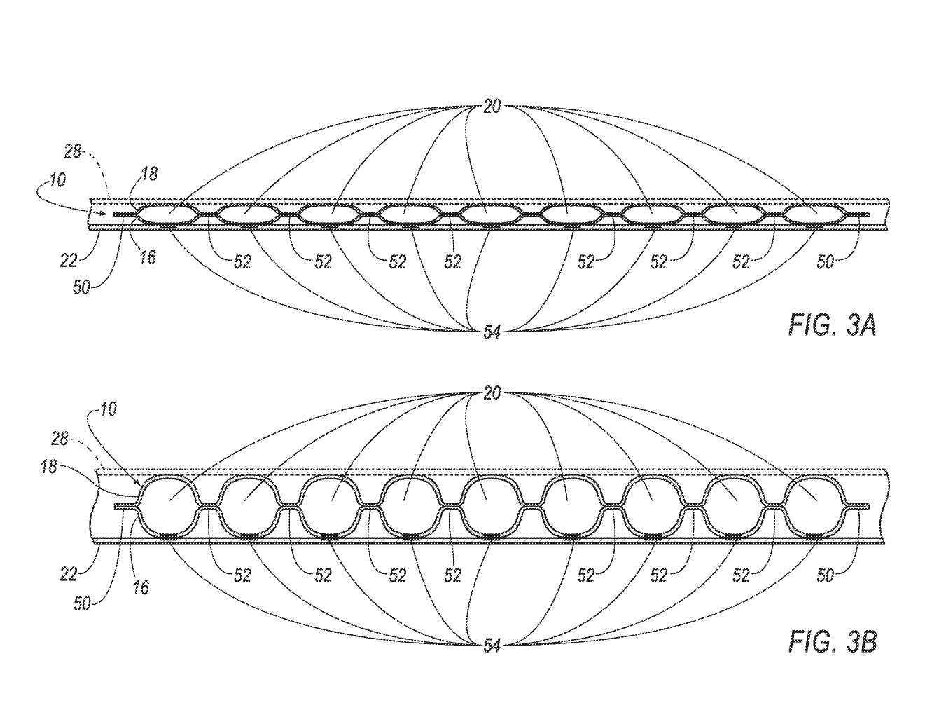

With reference to FIGS. 3A, 3B, 5A, and 5B, the bottom panel 16, 116 of the deployable device 10, 100 may be adjacent to the headliner 22, as shown in both embodiments of the deployable device 10, 100 in FIGS. 1-5B. The bottom panel 16, 116 of the deployable device 10, 100 may be fixed to the headliner 22. For example, the bottom panel 16, 116 may be adhered to the headliner 22 by an adhesive 54, e.g., water based adhesive, epoxy, etc. The adhesive 54 is configured to fix the bottom panel 16, 116 of the deployable device 10, 100 to the headliner 22 when the deployable device 10, 100 is in the undeployed position, as shown in FIGS. 3A and 5A. In addition, the adhesive 54 may be configured to fix the bottom panel 16, 116 to the headliner 22 when the deployable device 10, 100 is in the deployed position, as shown in FIGS. 3B and 5B. In the alternative to, or in addition to the adhesive 54, the deployable device 10, 100 may be fixed to the headliner in any suitable fashion.

With continued reference to FIGS. 1-5B, the top panel 18, 118 is opposite the bottom panel 16, 116. As shown in FIG. 1, the top panel 18, 118 is adjacent to the roof panel 28 and/or the crossmembers 32 of the vehicle 14. The top panel 18, 118 pushes against the roof panel 28 of the vehicle 14 when the deployable device 10, 100 is deployed from the undeployed position as shown in FIGS. 3A and 5A, to the deployed position as shown in FIGS. 3B and 5B. The top panel 18, 118 may be adjacent the roof panel 28 free of adhesive or other fasteners, e.g., in contact with and disconnected from the roof panel 28.

The deployable device 10, 100 may be configured to extend across the front passenger area 42 of the passenger compartment 38, as shown, for example, in FIGS. 2A, 2B, and 4. In addition, or in the alternative, the deployable device 10, 100 may be configured to extend across the rear passenger area 44 of the passenger compartment 38, as shown, for example, in FIG. 1. In addition, or in the alternative, the deployable device 10, 100 may be extended to span additional rows, e.g., third, fourth, etc. rows. The design of the deployable device 10, 100 minimizes the package thickness in the undeployed position in order to provide maximum headroom for the occupant 26. The deployable device 10, 100 in the deployed position may have a thickness in a direction from the headliner 22 to the roof panel 28 of 25-50 mm.

As set forth above, the deployable device 10, 100 is flexible relative to the headliner 22. During a rollover of the vehicle 14, the occupant 26 may contact the headliner 22 when the deployable device 10, 100 is in the deployed position. In this situation, since the deployable device 10, 100 is flexible relative to the headliner 22, the impact energy from the occupant 26 may be transferred through the headliner 22 and absorbed by the deployable device 10, 100.

In the first embodiment, as set forth above, the cavity 20 of the deployable device 10 may be defined to be between the top panel 18 and the bottom panel 16. The cavity 20 may be further defined by a perimeter 50 that is formed where the top panel 18 is fixed to the bottom panel 16. For example, the top panel 18 may be fixed to the bottom panel 16 by welding, e.g., ultrasonic welding, etc. As another example, the top panel 18 may be fixed to the bottom panel 16 by adhesive, e.g., epoxy adhesive, acrylic adhesive, etc. Alternatively, the top panel 18 may be integrally formed with the bottom panel 16, i.e., formed simultaneously as a single continuous unit to form the perimeter 50. For example, the top panel 18 and the bottom panel 16 may be, e.g., blow molded, injection molded, etc., from the same piece of material where the mold would form the perimeter 50.

Within the perimeter 50 of the first embodiment of the deployable device 10, the cavity 20 may be divided into channels 56, as best shown in FIGS. 2A-2B. The channels 56 are defined by walls 52. The walls 52 are formed where the top panel 18 is fixed to the bottom panel 16 (described below). The outermost channels 56 closest to the perimeter 50 are defined by the perimeter 50 and the walls 52. The channels 56 are spaced from each other by the walls 52, and each channel 56 extends along a longitudinal axis L parallel with each other, as shown in FIGS. 2A-2B.

As shown in FIGS. 3A-3B, the walls 52 are formed within the perimeter 50 where the top panel 18 is fixed to the bottom panel 16. For example, the top panel 18 may be fixed to the bottom panel 16 by welding, e.g., ultrasonic welding, etc. As another example, the top panel 18 may be fixed to the bottom panel 16 by adhesive, e.g., epoxy adhesive, acrylic adhesive, etc. Alternatively, the top panel 18 may be integrally formed with the bottom panel 16, i.e., formed simultaneously as a single continuous unit to form the walls 52. For example, the top panel 18 and the bottom panel 16 may be, e.g., blow molded, injection molded, etc., from the same piece of material where the mold would form the walls 52.

In the first embodiment, the deployable device 10 includes a manifold 58 in the cavity 20. For example, the manifold 58 may be disposed within the perimeter 50, and may be in communication with the all of the channels 56, as shown in FIGS. 1-2B. The manifold 58 configuration, e.g., length, width, and number of manifolds 58, may be defined by the layout of the walls 52. As shown in FIGS. 1-2B, for example, the longitudinal length of the channels 56 is defined by the walls 52, and the width of the manifold 58 in inversely proportional to the length of the channels 56. Specifically, the longer the longitudinal length of the walls 52, the shorter the width of the manifold 58. Alternatively, there may be more than one manifold 58, and the manifold 58 may be of any suitable size and shape, e.g., square, rectangle, round, etc. The purpose of the manifold 58 is to evenly distribute an inflation medium (not numbered, described below) to the channels 56.

With reference to the first embodiment of the deployable device 10, the channels 56 and manifold 58 may be configured to optimize the deployment of the deployable device 10. For example, the number of channels 56, length of channels 56, width of channels 56, size of manifold 58, etc. may be designed to provide the desired deployment time, i.e., time to inflate the deployable device 10 from the undeployed position to the deployed position. The thickness of the deployable device 10 when in the deployed position may also be controlled by the number and width of the channels 56. For example, increasing the number of channels 56 may decrease the deployable device 10 deployed thickness, and the deployed time. The channels 56 may minimize the rolling of the head of the occupant 26 by providing sliding resistance when the occupant 26 contacts the headliner 22 and the deployable device 10 during a rollover.

In the second embodiment, as set forth above, the cavity 20 of the deployable device 100 may be defined to be between the top panel 118 and the bottom panel 116. The cavity 20 may be further defined by a fold 60, as shown in FIGS. 4-5B. As set forth above, the cavity 20 of the second embodiment of the deployable device 100 is undivided. Specifically, the cavity 20 does not contain channels 56, manifolds 58 or walls 52.

The fold 60 may be integrally formed with the top panel 118, i.e., formed simultaneously as a single continuous unit. For example, the fold 60 and the top panel 118 may be blow molded from the same piece of material where the mold would contain the shape for the fold 60, e.g., zig-zag shape, S-shape, etc. Alternatively, the fold 60 and the top panel 118 may be formed separately and subsequently welded together, e.g., ultrasonic welded. In either case, the fold 60 is subsequently welded to the bottom panel 116 to form the cavity 20 of the deployable device 100, as shown in FIGS. 5A-5B. Alternatively, the fold 60 may be integrally formed with the bottom panel 116, i.e., formed simultaneously as a single continuous unit. For example, the fold 60 and the bottom panel 116 may be blow molded from the same piece of material, where the mold would contain the shape for the fold 60, e.g., zig-zag shape, S-shape, etc. In this case, the fold 60 is subsequently welded to the top panel 118 to form the cavity 20 of the deployable device 100. As yet another alternative, the fold 60, top panel 118, and bottom panel 116 may be formed simultaneously as a single continuous unit. For example, the fold 60, top panel 118, and bottom panel 116 may be blow molded from the same piece of material to form the cavity 20 of the deployable device 100, where the mold would contain the shape for the fold 60, e.g., zig-zag shape, S-shape, etc.

The top panel 18, 118, the bottom panel 16, 116 and the fold 60 may be formed of any suitable polymeric material with both thermoplastic and elastomeric properties, e.g., thermoplastic elastomers (TPEs). A suitable class of TPE material for the top panel 18, 118, bottom panel 16, 116 and the fold 60 may be, for example, thermoplastic olefin (TPO), etc. The properties of the deployable device 10, 100 in the deployed position may allow the top panel 18, 118, bottom panel 16, 116 and the fold 60, as well as the channels 56 and the manifold 58 to stretch to a size greater than their respective sizes when in the undeployed position. The material thicknesses of each of the top panel 18, 118, the bottom panel 16, 116, and the fold 60 may be uniform. The material thickness of the top panel 18, 118, the bottom panel 16, 116, and/or the fold 69 may be between 1-3 mm.

As shown in FIG. 4, the inflator 24 may be supported on the top panel 118 of the deployable device 100. Specifically, the top panel 118 may include a clip 64 that fixes the inflator 24 to the top panel 118 where the deployable device 100 and the inflator 24 may move as one unit. The clip 64 may be integrally formed with the top panel 118, i.e., formed simultaneously as a single continuous unit. For example, the clip 64 and the top panel 118 may be blow molded from the same piece of material, as set forth above, where the mold defines the shape for the clip 64. Alternatively, the clip 64, e.g., U-clip, spring clip, etc., and the top panel 118 may be formed separately and subsequently fastened together by rivets, threaded screws, adhesive, etc. The separately formed clip 64 may be formed of any suitable material, e.g., metal such as steel, aluminum, etc. Alternatively, for example, the separately formed clip 64 may be formed of an engineered plastic, e.g., acrylonitrile butadiene styrene (ABS), polyvinyl chloride (PVC), etc.

Alternatively, the inflator 24 may be supported by any of the crossmembers 32, for example, as shown in FIG. 1. Alternatively, the inflator 24 may be supported by the pillars 34 or side rails 36. For exemplary purposes, the inflator 24 is spaced from the first embodiment of the deployable device 10, as shown in FIGS. 1-2B, and the inflator 24 is mounted to the top panel 18, 118 of the second embodiment of the deployable device 100, as shown in FIG. 4. As set forth further below, the first embodiment of the deployable device 10 may be configured to mount the inflator 24 to the top panel 18, 118 of the deployable device 10, and the second embodiment of the deployable device 100 may be configured to have the inflator 24 spaced from the deployable device 100.

The inflator 24 expands the cavity 20 with the inflation medium, such as a gas. The inflator 24 may be, for example, a pyrotechnic inflator that uses a chemical reaction to drive inflation medium to the cavity 20. Alternatively, the inflator 24 may be, for example, a cold-gas inflator which, when activated, ignites a pyrotechnic charge that creates an opening for releasing the pressurized inflation medium to the cavity 20 via a fill tube 62 (described further below). The inflator 24 may be a cold-gas inflator. Alternatively, the inflator 24 may be of any suitable type, for example, a hybrid inflator.

With reference to FIGS. 1-2B and 4, the roof impact absorbing apparatus 12 may include the fill tube 62 extending from the inflator 24 to the cavity 20 of the deployable device 10, 100. The inflator 24 may have one or more ports (not numbered), e.g., one port as shown in the Figures, in communication with the cavity 20 through the fill tube 62. The roof impact absorbing apparatus 12 may include one or more fill tubes 62, e.g., one fill tube 62 as shown in the Figures. The cavity 20 may include any suitable number of connection points 66, e.g., one connection point 66 as shown in the Figures, spaced from each other to receive the fill tube 62.

The fill tube 62 may be formed of any suitable high strength flexible material. For example, the fill tube 62 may be nitrile rubber, nylon, thermoplastic elastomer (TPE), etc.

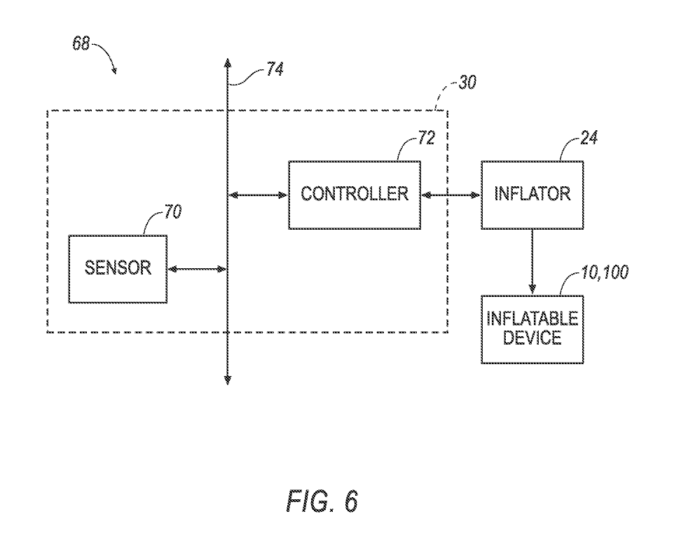

A schematic of the rollover impact absorbing system 68, which includes a rollover sensing system 30, the inflator 24, and the deployable device 10, 100, is shown in FIG. 6. The rollover sensing system 30 may include a sensor 70 for sensing a rollover of the vehicle 14, and a controller 72 in communication with the sensor 70 and the inflator 24 for activating the inflator 24, e.g., for providing an impulse to a pyrotechnic charge of the inflator 24, when the sensor 70 senses a rollover of the vehicle 14. Alternatively or additionally to sensing a rollover, the rollover sensing system 30 may be configured to sense a rollover prior to an actual rollover, i.e., pre-rollover sensing. The sensor 70 may be of any suitable type, e.g., using radar, lidar, and/or a vision system. The vision system may include one or more cameras, CCD image sensors, and/or CMOS image sensor, etc.

The controller 72 may be a microprocessor-based controller. The sensor 70 is in communication with the controller 72 to communicate data to the controller 72. Based on the data communicated by the sensor 70, the controller 72 instructs the inflator 24 to activate. The controller 72 may be programmed to activate the inflator 24 to inflate the cavity 20 of the deployable device 10, 100 to the deployed position in response a rollover of the vehicle 14.

The controller 72 and the sensor 70 may be connected to a communication bus 74, such as a controller area network (CAN) bus, of the vehicle 14. The controller 72 may use information from the communication bus 74 to control the activation of the inflator 24. The inflator 24 may be connected to the controller 72, as shown in FIG. 6, or may be connected directly to the communication bus 74.

In operation, the cavity 20 of the deployable device 10, 100 is in the undeployed position, as shown in FIGS. 1, 2A, 3A, 4 and 5A, under normal operating conditions of the vehicle 14. When the sensor 70 senses a rollover of the vehicle 14, the rollover sensing system 30 triggers the inflator 24 to inflate the cavity 20 with the inflation medium from the undeployed position to the deployed position. In particular, upon sensing a rollover of the vehicle 14, the rollover sensing system 30 inflates the cavity 20 of the deployable device 10, 100 to the deployed position as shown in FIGS. 2B, 3B and 5B.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle roof impact absorbing apparatus comprising:
a headliner;
a deployable device including a bottom panel adjacent the headliner, a top panel opposite the bottom panel, and a cavity between the top panel and the bottom panel;
an inflator in communication with the cavity; and
the deployable device being formed of a thermoplastic elastomer and being flexible relative to the headliner.

2. The vehicle roof impact absorbing apparatus as set forth in claim 1, wherein the inflator is mounted to the top panel.

3. The vehicle roof impact absorbing apparatus as set forth in claim 1, further comprising a clip fixed to the top panel and engaging the inflator.

4. The vehicle roof impact absorbing apparatus as set forth in claim 3, wherein the clip is integral with the top panel.

5. The vehicle roof impact absorbing apparatus as set forth in claim 1, wherein the deployable device includes channels in the cavity between the top panel and the bottom panel.

6. The vehicle roof impact absorbing apparatus as set forth in claim 5, wherein the deployable device includes a manifold in the cavity in communication with the channels.

7. The vehicle roof impact absorbing apparatus as set forth in claim 5, wherein the channels each extend along a longitudinal axis parallel with each other.

8. The vehicle roof impact absorbing apparatus as set forth in claim 5, wherein the top panel is fixed to the bottom panel forming a wall defining the channels.

9. The vehicle roof impact absorbing apparatus as set forth in claim 1, wherein the deployable device includes a fold along the cavity between the top panel and the bottom panel.

10. A vehicle roof impact absorbing apparatus comprising:
a deployable device including a bottom panel, a top panel opposite the bottom panel, and a cavity between the top panel and the bottom panel;
an inflator in communication with the cavity; and
the inflator is mounted to the top panel.

11. The vehicle roof impact absorbing apparatus as set forth in claim 10, further comprising a clip fixed to the top panel and engaging the inflator.

12. The vehicle roof impact absorbing apparatus as set forth in claim 11, wherein the clip is integral with the top panel.

13. The vehicle roof impact absorbing apparatus as set forth in claim 10, further comprising a headliner adjacent to the bottom panel.

14. The vehicle roof impact absorbing apparatus as set forth in claim 13, wherein the headliner is rigid relative to the deployable device.

15. The vehicle roof impact absorbing apparatus as set forth in claim 14, wherein the deployable device is formed of a thermoplastic elastomer.

16. The vehicle roof impact absorbing apparatus as set forth in claim 10, wherein the deployable device includes channels in the cavity between the top panel and the bottom panel.

17. The vehicle roof impact absorbing apparatus as set forth in claim 16, wherein the deployable device includes a manifold in the cavity in communication with the channels.

18. The vehicle roof impact absorbing apparatus as set forth in claim 16, wherein the channels each extend along a longitudinal axis parallel with each other.

19. The vehicle roof impact absorbing apparatus as set forth in claim 16, wherein the top panel is fixed to the bottom panel forming a wall defining the channels.

20. The vehicle roof impact absorbing apparatus as set forth in claim 10, wherein the deployable device includes a fold along the cavity between the top panel and the bottom panel.
